(19) United States
(12) Patent Application Publication
(10) Pub. No.: US 2006/0280336 A1
(43) Pub. Date: Dec. 14, 2006

(54) SYSTEM AND METHOD FOR DISCRIMINATING PASSENGER ATTITUDE IN VEHICLE USING STEREO IMAGE JUNCTION

(76) Inventor: Seok Joo Lee, Icheon-shi (KR)

Correspondence Address: IPLA P.A., 3580 WILSHIRE BLVD., 17TH FLOOR, LOS ANGELES, CA, 90010, US

(21) Appl. No.: 11/422,061

(22) Filed: Jun. 2, 2006

(30) Foreign Application Priority Data
Jun. 8, 2005 (KR) 10-2005-0048649

(51) Int. Cl. G06K 9/00; B60R 21/015

(52) U.S. Cl. 382/104; 280/735

(57) ABSTRACT

A system and method for discriminating a passenger attitude in a vehicle using a stereo image junction is provided. The system includes: a controller for generating an airbag control signal for enabling an airbag depending on the passenger attitude; an image obtaining unit having at least two cameras, and capturing an image of a vehicle interior and generating stereo two-dimensional image data; a preprocessor for receiving the stereo two-dimensional image data, correcting distortion of the received two-dimensional image data, and generating three-dimensional model information; and a digital signal processor for receiving and analyzing the corrected stereo two-dimensional image data and the three-dimensional model information to discriminate the passenger attitude, and generating and outputting passenger attitude information to the controller.

### BACKGROUND OF THE INVENTION

1. Field of the Invention

The present invention relates to a system for discriminating a passenger attitude in a vehicle, and more particularly, to a system and method for discriminating a passenger attitude in a vehicle using a stereo image junction, by obtaining a stereo two-dimensional image and generating a three-dimensional map.

2. Description of the Related Art

At present, as a car industry develops and a society gets complex, a sphere of activity is expanded and accordingly, a demand for a car is continuously increased in order to minimize a waste of time and move with more convenience. As the demand for the car is increased, a percentage of a traffic accident is increased.

As the traffic accident is increased, a passenger protection system for protecting a passenger is installed in the car. One of the passenger protection systems is an airbag system.

The airbag system includes a collision sensor provided at a car bumper and sensing a physical collision. When receiving a collision signal resulting from collision from the collision sensor, the airbag system enables an airbag to protect the passenger. In recent years, the passenger attitude is discriminated as to whether the passenger is an adult or a child and as to whether or not the passenger leans against a window, and the airbag is enabled to protect the passenger as much as possible depending on the passenger attitude. For this, a passenger attitude discrimination system is installed in the car to discriminate the passenger attitude.

In general, in the passenger attitude discrimination system, a pressure sensor is installed at a seat to measure a weight of the passenger, and an infrared ray sensor or an ultrasonic wave sensor is installed around the passenger to measure a distance from a driver reference position and discriminate the passenger attitude. However, a method using the pressure sensor, the infrared ray sensor, and the ultrasonic wave sensor has a limitation in accurately discriminating the passenger attitude.

As described above, the conventional passenger attitude discrimination system has a drawback in that it is difficult to accurately discriminate the passenger and the passenger attitude using only a sensed value of the used sensor.

### SUMMARY OF THE INVENTION

Accordingly, the present invention is directed to a system and method for discriminating a passenger attitude in a vehicle using a stereo image junction that substantially overcomes one or more of the limitations and disadvantages of the conventional art.

One object of the present invention is to provide a system and method for discriminating a passenger attitude in a vehicle using a stereo image junction, by obtaining a stereo two-dimensional image and generating a three-dimensional map.

Additional advantages, objects, and feature points of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve the above and other objects and advantages, and in accordance with the purpose of the invention, as embodied and broadly described herein, there is provided a system for discriminating a passenger attitude in a vehicle using a stereo image junction, the system including: a controller for generating an airbag control signal for enabling an airbag depending on the passenger attitude; an image obtaining unit having at least two cameras, and capturing an image of a vehicle interior and generating stereo two-dimensional image data; a preprocessor for receiving the stereo two-dimensional image data, correcting distortion of the received two-dimensional image data, and generating three-dimensional model information; and a digital signal processor for receiving and analyzing the corrected stereo two-dimensional image data and the three-dimensional model information to discriminate the passenger attitude, and generating and outputting passenger attitude information to the controller.

In another aspect of the present invention, there is provided a method for discriminating a passenger attitude using a stereo image junction, in a vehicle having a controller for generating an airbag control signal for enabling an airbag depending on the passenger attitude, the method including the steps of: capturing an image of a vehicle interior using at least two cameras, and generating stereo two-dimensional image data; receiving the stereo two-dimensional image data, correcting distortion of the received two-dimensional image data, and generating three-dimensional model information; receiving and analyzing the corrected stereo two-dimensional image data and the three-dimensional model information to discriminate the passenger attitude; and generating and outputting passenger attitude information to the controller.

It is to be understood that both the foregoing summary and the following detailed description of the present invention are merely exemplary and intended for explanatory purposes only.

### BRIEF DESCRIPTION OF THE DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 illustrates a construction of a system for discriminating a passenger attitude in a vehicle using a stereo image junction according to the present invention;

FIG. 2 is a flowchart illustrating a method for discriminating a passenger attitude in a vehicle using a stereo image junction according to the present invention;

FIG. 3 illustrates an attitude classification map for detecting a head position according to the present invention;

FIG. 4 illustrates a method for detecting a head position according to the present invention;

FIG. 5 illustrates a concept of extracting a contour of a passenger according to the present invention; and

FIG. 6 illustrates a concept of support vector machine (SVM) classification for detecting a passenger head according to the present invention.

### DETAILED DESCRIPTION OF THE INVENTION

Reference will now be made in detail to the preferred embodiments of the present invention, examples of which are illustrated in the accompanying drawings. Wherever possible, the same reference numerals will be used throughout the drawings to refer to the same or like parts.

In the present invention, a stereo two-dimensional image is obtained through two cameras, the obtained stereo two-dimensional image is junctioned to thereby generate three-dimensional map information, the stereo two-dimensional image and the three-dimensional map information are analyzed to thereby generate real-time passenger information. The three-dimensional map information refers to three-dimensional information such as a distance or a height.

The passenger information includes information on whether a passenger is an adult, a child, a male, or a female, and includes passenger attitude information on whether the passenger slants to the left or right and to the front and whether or not the passenger leans against a seat.

Hereinafter, a construction and an operation of a system for controlling a passenger attitude using a stereo two-dimensional image junction according to the present invention will be described.

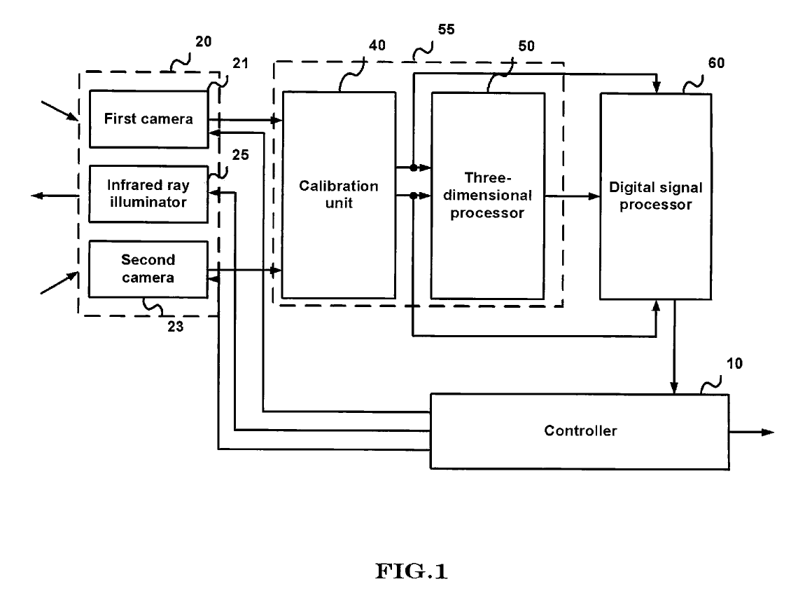

FIG. 1 illustrates a construction of a system for discriminating the passenger attitude in a vehicle using the stereo image junction according to the present invention.

Referring to FIG. 1, the inventive passenger attitude discriminating system includes a controller 10, an image obtaining unit 20, a preprocessor 55, and a digital signal processor 60.

The controller 10 controls a general operation of the passenger attitude discriminating system using the stereo image junction.

The image obtaining unit 20 includes a first camera 21 and a second camera 23 installed inside and to front left and right of a vehicle, and photographing a vehicle interior and outputting stereo two-dimensional image data on the photographed vehicle interior.

The preprocessor 55 includes a calibration unit 40 and a three-dimensional image processor 50. The calibration unit 40 receives the stereo two-dimensional image data through the first and second cameras 21 and 23, and corrects distortion of the received two-dimensional image data. The three-dimensional image processor 50 generates a three-dimensional model from the corrected stereo two-dimensional image data.

The three-dimensional image processor 50 receives the corrected stereo two-dimensional image data, obtains a feature point of an image from two frames of the corrected two-dimensional image data, and obtains a corresponding relationship between the frames, thereby generating the three-dimensional model.

In the present invention, the image obtaining unit 20 includes an infrared ray illuminator 25 for irradiating infrared rays inside a car so as to, when the three-dimensional image processor 50 generates the three-dimensional model, prevent a reliability of obtained height information from being deteriorated due to change of an external condition, that is, change of an illumination condition, a texture, existence of a shade area.

The digital signal processor 60 receives the corrected two-dimensional image data and information on the three-dimensional model from the calibration unit 40 and the three-dimensional image processor 50 respectively, analyzes the received two-dimensional image data and three-dimensional model information, detects a passenger's head position, discriminates the passenger attitude depending on the detected head position, generates the passenger attitude information based on the detected head position and the discriminated passenger attitude, and outputs the generated passenger attitude information to the controller 10.

The controller 10 receives the passenger attitude information, generates an airbag control signal depending on the passenger attitude information, and provides the generated airbag control signal to an airbag module (not shown).

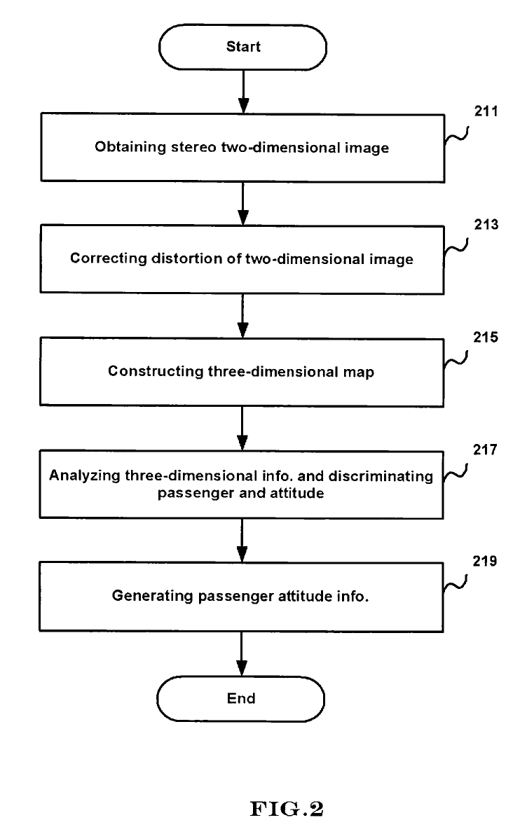

FIG. 2 is a flowchart illustrating a method for discriminating the passenger attitude in the vehicle using the stereo image junction according to the present invention. Hereinafter, a description will be made with reference to FIG. 2.

First, in Step 211, a stereo two-dimensional image is obtained through the first and second cameras 21 and 23 of the image obtaining unit 20, the obtained stereo two-dimensional image is converted into the stereo two-dimensional image data, and the converted stereo two-dimensional image data is outputted to the calibration unit 40.

The calibration unit 40 receives the stereo two-dimensional image data in the Step 211 and then, corrects respective distortions of the received two-dimensional image data in Step 213. The corrected two-dimensional image data is inputted to the three-dimensional image processor 50 and the digital signal processor 60.

In Step 215, the three-dimensional image processor 50 receives the corrected two-dimensional image data, extracts the feature points from the stereo, that is, two-framed two-dimensional image data, obtains the corresponding relationship between the feature points, and generates the three-dimensional model information.

Upon outputting of the three-dimensional model information in the Step 215, the digital signal processor 60 analyzes the three-dimensional model information and the corrected two-dimensional image data, detects the passenger head position, detects the passenger head, and discriminates the passenger attitude in Step 217, and generates and outputs the passenger attitude information based on the discriminated passenger attitude to the controller 10 in Step 219.

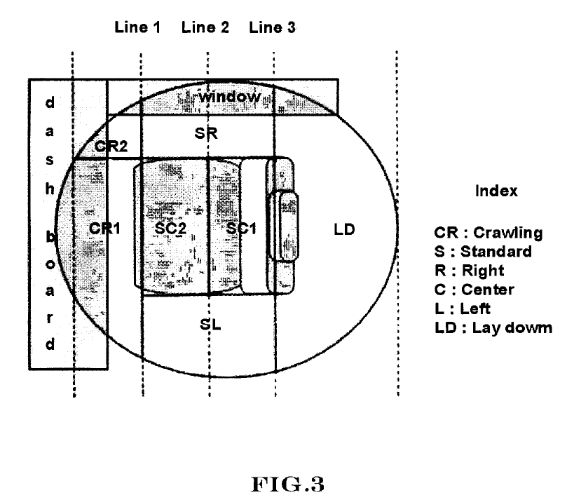

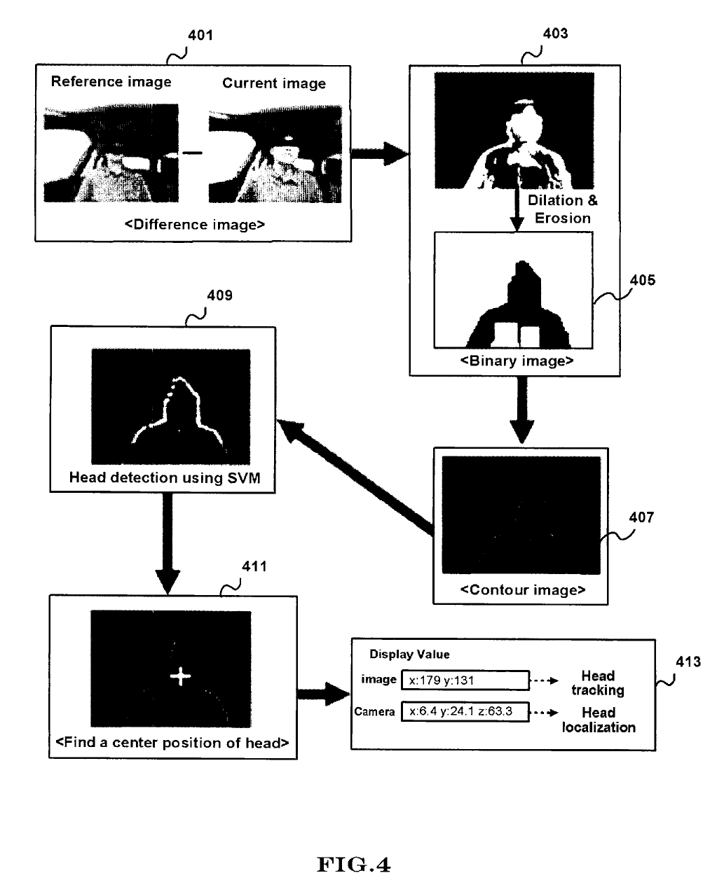

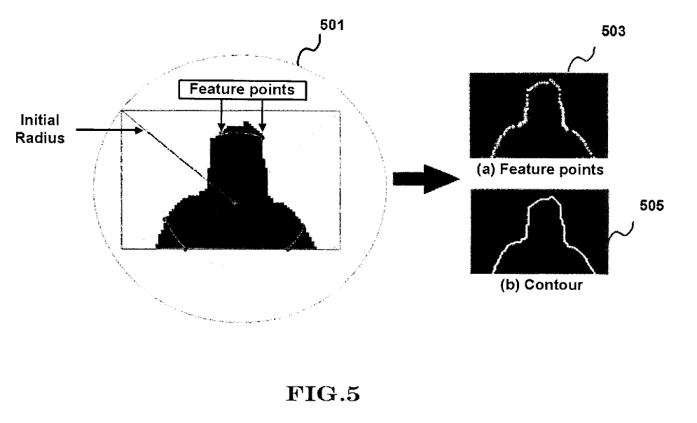

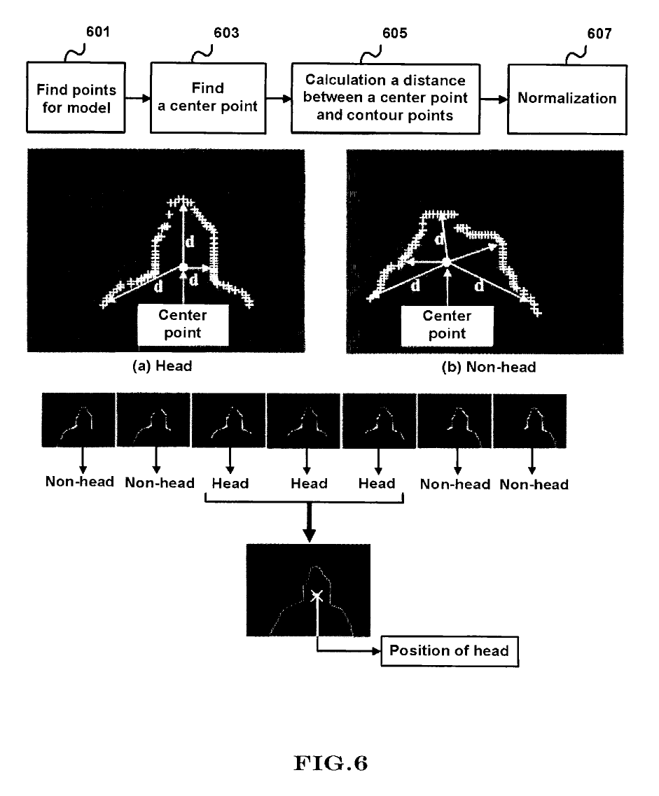

FIG. 3 illustrates an attitude classification map for detecting the head position according to the present invention, FIG. 4 illustrates a method for detecting the passenger head position according to the present invention, FIG. 5 illustrates a concept of extracting a contour of the passenger according to the present invention, and FIG. 6 illustrates a concept of support vector machine (SVM) classification for detecting the passenger head according to the present invention.

An operation of the digital signal processor 60 will be in detail described with reference to FIGS. 3 to 6 below.

As shown in FIG. 3, the digital signal processor 60 having an attitude discrimination map compares a relationship between the attitude discrimination map and the corrected two-dimensional image data, thereby determining whether the passenger head is in any position of the seat. In FIG. 3, the attitude discrimination map is sectioned by three lines on the basis of a dash board, and distinguishes a head positioned region on the basis of left and right lines of the seat. In FIG. 3, “SC1” denotes a first central standard region, “SC2” denotes a second central standard region, “SR” denotes a right standard region, “SL” denotes a left standard region, “CR1” denotes a first slant region, and “CR2” denotes a second slant region. The passenger attitude including the height (Z-axis value) can be discriminated using the attitude discrimination map of FIG. 3.

In FIG. 4, the passenger head can be detected, thereby recognizing the head position in the two-dimensional image. In detail, in Step 401, upon obtaining of the stereo two-dimensional (X and Y axes) image, a background image is removed. In Step 403, the two-dimensional image with the background image removed is subject to dilation and erosion operations. In Step 405, a binary image is generated. Upon generation of the binary image, a contour image of the binary image is generated in Step 407. Upon generation of the contour image in the Step 407, the head is detected from the contour image using a SVM in Step 409. Upon detection of the head from the contour image in the Step 409, a center point of the head is found in Step 411. In Step 413, the found center point (X and Y information), head position information (X, Y, and Z information) of a camera image, and the passenger attitude information are generated.

In a method for detecting the contour from the binary image, as in Step 501 of FIG. 5, a diameter of a circle is enlarged centering on a centroidal position of the binary image while the feature points are extracted, and the contour is extracted on the basis of the extracted feature points. Reference numeral 503 denotes the feature points, and reference numeral 505 denotes the contour generated on the basis of the feature points.

In the method for detecting the passenger head, in Step 601 of FIG. 6, points for the three-dimensional model are found. In Step 603, the center point of the contour is found. In Step 605, distances between the found center point and predetermined points of the contour are calculated. In Step 607, the distances are normalized, thereby, when it is determined to be identical with a predefined head pattern, determining the predefined head pattern as the head.

Upon generation of the passenger attitude information as described above, the controller 10 receives the passenger attitude information, generates the airbag control signal depending on the passenger attitude information, and outputs the generated airbag control signal to the airbag module. The airbag module enables an airbag depending on the airbag control signal.

As described above, the present invention has an advantage in that, since the passenger attitude can be more accurately discriminated using the camera, the airbag can be enabled depending on the passenger attitude.

Accordingly, the present invention has an advantage in that, since the airbag is enabled adaptively to the passenger attitude, the passenger can be more safely protected.

While the present invention has been described with reference to exemplary embodiments thereof, it will be apparent to those skilled in the art that various modifications can be made therein without departing from the spirit and scope of the invention as defined by the appended claims and their equivalents.

What is claimed is:

1. A system for discriminating a passenger attitude in a vehicle using a stereo image junction, the system comprising:
a controller for generating an airbag control signal for enabling an airbag depending on the passenger attitude;
an image obtaining unit having at least two cameras, and capturing an image of a vehicle interior and generating stereo two-dimensional image data;
a preprocessor for receiving the stereo two-dimensional image data, correcting distortion of the received two-dimensional image data, and generating three-dimensional model information; and
a digital signal processor for receiving and analyzing the corrected stereo two-dimensional image data and the three-dimensional model information to discriminate the passenger attitude, and generating and outputting passenger attitude information to the controller.

2. The system according to claim 1, wherein the image obtaining unit comprises an infrared rays illuminator for irradiating infrared rays to secure a reliability of height information from a change of an illumination condition, a texture, existence of a shade area.

3. A method for discriminating a passenger attitude using a stereo image junction, in a vehicle having a controller for generating an airbag control signal for enabling an airbag depending on the passenger attitude, the method comprising the steps of:
capturing an image of a vehicle interior using at least two cameras, and generating stereo two-dimensional image data;
receiving the stereo two-dimensional image data, correcting distortion of the received two-dimensional image data, and generating three-dimensional model information;
receiving and analyzing the corrected stereo two-dimensional image data and the three-dimensional model information to discriminate the passenger attitude; and
generating and outputting passenger attitude information to the controller.

4. The method according to claim 3, wherein the discriminating of the passenger attitude comprises the steps of:
determining a position (X, Y, and Z) of a passenger; and
determining a head position (X and Y) of the passenger.

5. The method according to claim 4, wherein the determining of the head position of the passenger comprises the steps of:
removing a background image from an obtained image;
performing dilation and erosion operations for the image with the background image removed, and generating a binary image;
generating a contour image from the binary image; and
detecting a passenger head from the contour image.

6. The method according to claim 5, wherein a contour of the contour image is detected by enlarging a diameter of a circle centering on a centroidal position of the binary image while extracting a feature point.
